(19) United States
(12) Patent Application Publication
(10) Pub. No.: US 2011/0191142 A1
(43) Pub. Date: Aug. 4, 2011

(54) USING NETWORKING SITE INTERACTIONS TO GENERATE A TARGET LIST OF POTENTIAL CONSUMERS

(75) Inventors: JIAYUAN HUANG, SAMMAMISH, WA (US); BHAUMIK CHOKSHI, REDMOND, WA (US); VALERI LIBORSKI, WOODINVILLE, WA (US); GERARD GJONEJ, SEATTLE, WA (US)

(73) Assignee: MICROSOFT CORPORATION, REDMOND, WA (US)

(21) Appl. No.: 12/700,046

(22) Filed: Feb. 4, 2010

(51) Int. Cl. G06Q 30/00; G06Q 10/00; G06F 17/30

(52) U.S. Cl. 705/7.33; 705/14.53; 705/14.54; 707/770; 707/E17.032

(57) ABSTRACT

Embodiments of the present invention relate to systems, methods, and computer-storage media for providing a method of presenting advertisements to a target group of potential consumers generated from a group of seed consumers. In one embodiment, a target list request is received from an advertiser. A set of seed consumers associated with the advertiser is then determined. A set of potential consumers is then determined based on the set of seed consumers. Further, a subset of the set of potential consumers is determined, each potential consumer of the subset having a common characteristic. A target list of potential consumers is then generated comprising at least a portion of the subset of potential consumers. The target list of potential consumers is then provided to the advertiser.

### BACKGROUND

Merchants are interested in presenting advertisements to potential consumers who are likely to act in response to the advertisements presented. For example, sellers of sporting goods may present commercials for sporting products during sporting events, such as a televised football game. Clearly by spending resources on the consumer groups most likely to be responsive, merchants gain efficiency in money spent on advertisements.

### SUMMARY

This Summary is provided to introduce a selection of concepts in a simplified form that are further described below in the Detailed Description. This Summary is not intended to identify essential features of the claimed subject matter, nor is it intended to be used as an aid in isolation to determine the scope of the claimed subject matter. Embodiments of the present invention provide methods for generating target groups of potential consumers based on a set(s) of seed consumers associated with an advertiser, such as a merchant. In particular, methods are provided to receive a request(s) from an advertiser and provide advertisements to potential consumers of a target list generated in response to the request from the advertiser.

Embodiments of the present invention relate to systems, methods, and computer-storage media for providing advertisements to a target group of potential consumers of a merchant's products. In embodiments, the target group of potential consumers is generated from a group of seed consumers. In one embodiment, a target list request is received from an advertiser, such as a merchant, and a set of seed consumers associated with the advertiser is identified. A second set of potential consumers is then determined based on networking site interactions of the set of seed consumers and a third set of potential consumers is determined based on the second set of potential consumers. In embodiments, the third set of potential consumers is determined by filtering the second set of potential consumers. For example, each potential consumer of the third set may share a common characteristic, such as an interest in a certain type of sport. A target list of potential consumers is then generated that includes at least a portion of the third set of potential consumers. The target list of potential consumers is then provided to the advertiser.

### BRIEF DESCRIPTION OF THE SEVERAL VIEWS OF THE DRAWINGS

Illustrative embodiments of the present invention are described in detail below with reference to the attached drawing figures:

FIG. 1 illustrates an exemplary computing device suitable for use in connection with embodiments of the present invention;

FIG. 2 illustrates an exemplary listing of seed consumers associated with a merchant, in accordance with an embodiment of the present invention;

FIG. 3 illustrates exemplary first-degree friends of one of the seed consumers of FIG. 2 (Potential consumer A), in accordance with an embodiment of the present invention;

FIG. 4 illustrates an exemplary filtered listing of the first-degree friends shown in FIG. 3, in accordance with an embodiment of the present invention;

FIG. 5 illustrates an alternative filtered listing of the first-degree friends shown in FIG. 3, in accordance with an embodiment of the present invention;

FIG. 6 illustrates a further filtered listing of the first-degree friends shown in FIG. 3, in accordance with an embodiment of the present invention;

FIG. 7 illustrates exemplary first-degree friends and second-degree friends of one of the seed consumers of FIG. 2 (Potential consumer A), in accordance with an embodiment of the present invention;

FIG. 8 illustrates an exemplary filtered listing of first-degree friends and second-degree friends of FIG. 7, in accordance with an embodiment of the present invention;

FIG. 9 illustrates exemplary filtered second-degree friends of filtered first-degree friends of FIG. 8, in accordance with an embodiment of the present invention;

FIG. 10 is a flow diagram illustrating a method of generating a target list of potential consumers based on networking site interactions of the potential consumers with consumers, in accordance with an embodiment of the present invention;

FIG. 11 is a flow diagram illustrating a method of presenting advertisements to a target list of potential consumers generated from a set of seed consumers based on networking site interactions of the potential consumers with seed consumers of the set of seed consumers, in accordance with an embodiment of the present invention; and

FIG. 12 is a flow diagram illustrating a method of presenting advertisements to a target list of a threshold number of potential consumers generated from a group of seed consumers based on networking site interactions of the potential consumers with seed consumers of the group of seed consumers, in accordance with an embodiment of the present invention.

### DETAILED DESCRIPTION

The subject matter of embodiments of the present invention is described with specificity herein to meet statutory requirements. Although the terms “step,” “block” and/or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems, methods, and computer-storage media for providing advertisements to a target group of potential consumers of a merchant's products and/or services. In embodiments, the target group of potential consumers is generated from a group of seed consumers. In one embodiment, a target list request is received from an advertiser, such as a merchant, and a set of seed consumers associated with the merchant is identified. A second set of potential consumers is then determined based on networking site interactions the set of seed consumers and a third set of potential consumers is determined based on networking site interactions of the second set of potential consumers. In embodiments, the third set of potential consumers is determined by filtering the second set of potential consumers. For example, each potential consumer of the third set of potential consumers may share a common characteristic, such as an interest in a certain type of sport. A target list of potential consumers is then generated that includes at least a portion of the third set of potential consumers, each potential consumer on the target list also being a member of the third set of potential consumers. The target list of potential consumers is then provided to the advertiser in response to the request for the target list.

In accordance with embodiments of the present invention, a merchant may request a target list of potential consumers for a particular product or service. For example, a sporting goods merchant may request a target list of potential consumers for a basketball. However, the merchant may have an advertising budget that only allows for presentation of 20,000 targeted advertisements, a targeted advertisement comprising an advertisement presented on a computing device of a targeted potential consumer. In order to maximize the effectiveness of the 20,000 advertisements for a basketball, the sporting goods merchant may desire to allocate the 20,000 advertisements to potential consumers who would be most likely to respond to the advertisement for a basketball by increasing the merchant's business, for example: buying a basketball, visiting the sporting goods merchant's store, visiting the sporting goods merchant's webpage, and/or referencing the sporting goods merchant for future sporting goods purchases. In order to develop a target list of potential consumers, the merchant may request a target list of potential consumers to be associated with an advertisement. In alternative embodiments, a merchant may hire an advertising agency to efficiently allocate a budget of advertisements to present to potential consumers. Accordingly, an advertiser hired by a merchant may request a target list of potential consumers for an advertisement. Embodiments of the present invention described herein discuss an “advertising entity” as the merchant or anyone associated with or acting on behalf of or at the direction of the merchant, for instance, an advertising agency.

As utilized herein, an advertiser may be a person, group, and/or organization, or a third party associated with a person, group, and/or organization. As such, embodiments of the present invention comprise the generation of a target list of potential consumers to be presented with advertisements. Advertisements may include information regarding events, requests for membership to an organization, charitable groups, meetings, and/or any other dissemination of information that a merchant would want to present to a targeted group of potential consumers rather than to a group of general potential consumers. A target list may also comprise potential consumers that are within a designated geographic area, such as potential consumers that are near a venue that is advertising for a free concert. For example, the venue may be associated with a blog that highlights upcoming events on the blog. Using seed consumers that have subscribed to the blog, a second set of potential consumers may be determined, where the second set of potential consumers are networking site relations of at least one seed consumer and are one or more degrees of separation from the at least one seed consumer. In this way, the second set of potential consumers may approximate a global view of users' connectivity. Further, a third set of potential consumers may be determined comprising potential consumers of the second set that share a characteristic, e.g., being in the same city, state, and/or geographic area of the venue. In embodiments, the third set of potential consumers is derived from the second set of potential consumers. As such, the third set of potential consumers may comprise characteristics that are closer to the characteristics of the seed consumers. In this way, each potential consumer of the third set of potential consumers may have characteristics that are more similar to seed consumers than those of the average potential consumer in the second set of potential consumers.

A target list may then be generated, where the target list comprises at least a portion of the third set of potential consumers, each potential consumer on the target list also being a member of the third set of potential consumers. By utilizing methods described herein to generate a target list of potential consumers, an advertiser may gain efficiency in money and efforts used to advertise events and/or disseminate information.

Embodiments of the present invention provide methods for developing a target list of users, such as potential consumers, based on a seed set of consumers having networking site relations with potential consumers. An initial set of seed consumers may comprise consumers who are associated with an advertiser, such as a merchant, originating the request for the target list. In embodiments, seed consumers may be associated with a merchant in a number of ways. For example, a seed consumer may be associated with a merchant based on the seed consumer buying an item from the merchant within a threshold amount of time. Additionally, a seed consumer may be associated with a merchant if the seed consumer has bought an item from a competitor of the merchant within a threshold period of time. Further, a seed consumer may be associated with a merchant based on the seed consumer's subscription to a blog associated with the merchant. Additionally, seed consumers associated with the merchant may comprise consumers who have visited a web site of a merchant; signed up for a mailing list of the merchant; and/or purchased at least one service from the merchant.

In order to determine networking site relations of a seed consumer with a merchant, the seed consumer may be registered with a networking site, such as a messaging service and/or social-networking service, that allows interactions of the consumer with his/her networking site relations to be tracked. A messaging service encompasses any type of service that facilitates electronic communications, such as e-mail, text messaging, instant messaging, etc., between users. A social networking site encompasses sites directed at facilitating the maintenance, analysis, and/or expansion of a user's social network. Many social networking sites include the ability for a user to register on the social networking site, but this is not a required limitation for embodiments discussed in the application herein. Rather, networking site relations may be determined based on other identifying factors beyond the registration of a user to a networking site. For example, the electronic signature, IP address, or content of electronic communications and/or behaviors being tracked may serve as identifiers of users who utilize and interact on networking sites. In embodiments, the networking site affiliates of a user may be categorized as the user's “friends.” The term “friends” encompasses users who are proactively listed as friends on a networking site of a user, but also encompasses other users of networking services who are either not proactively listed as friends of the user or who are not registered at a particular networking site.

Once a set of seed consumers has been determined, a set of potential consumers may be determined based on the set of seed consumers. In embodiments of the present invention, a set of potential consumers may be determined based on the messenger service and/or social-networking service of each seed consumer. In other words, a set of potential consumers may be determined, where the set of potential consumers comprises all of the friends of each seed consumer. Each friend of a seed consumer may comprise a first-degree friend of the seed consumer, where a first-degree friend comprises a friend who has interaction with the seed consumer. In embodiments, the set of potential consumers may comprise potential consumers that are at least a first-degree friend of a seed consumer.

A first-degree friend of a seed consumer may also and/or alternatively comprise a potential consumer who subscribes to a blog hosted by the seed consumer; a potential consumer who has been e-mailed by and/or who has e-mailed the seed consumer; and/or a potential consumer whose profile the seed consumer has viewed. Given the large number of first-degree friends associated with a typical seed consumer, many embodiments described herein focus on one originating seed consumer in order to clarify at least a filtering process of the set of potential consumers.

Once a set of potential consumers has been determined, merchants may desire to have the set of potential consumers filtered to maximize the effectiveness of an advertisement. For example, even if each seed consumer of the set of seed consumers has purchased a basketball within the previous month, each seed consumer will likely have a number of messenger service and/or social-networking service friends who have a low interest in sporting topics. In light of the increasing popularity of messenger services and social-networking services, it is common for users of said services to have tens, if not hundreds, of friends. Accordingly, it may be beneficial to narrow down friends of seed consumers to target potential consumers who would most likely be interested in an advertisement related to the merchant. In the example above concerning a basketball advertisement, it would be beneficial to target advertisements to potential consumers who would also be interested in buying a basketball and/or other sporting equipment from the sporting goods merchant.

Alternatively and/or additionally, it may be beneficial to target advertisements to friends of a seed consumer who would likely be influenced by the seed consumer. While potential consumers who would likely be influenced by a seed consumer may not have a strong personal desire to own a new basketball, the potential consumers may have a desire to be like a seed consumer who buys basketballs. Accordingly, a target list may comprise potential consumers who are easily influenced. Potential consumers who are easily influenced may purchase a service and/or item to be more like a seed consumer, even if the easily influenced potential consumer would not have otherwise purchased the item. An example of potential consumers who may be influenced by a seed consumer includes potential consumers who subscribe to a seed consumer's update feed, such as on a blog or an updated feed site such as Twitter®. For example, if a potential consumer is interested in hearing the most recent updates of a seed consumer, the potential consumer may be more likely to purchase an item once the potential consumer has learned the seed consumer has purchased the item. In this example, it may be advantageous for an advertiser to present an advertisement related to a basketball to the followers of a seed consumer's blog and/or update feed.

In embodiments, it may be preferable for an advertiser to present an advertisement related to a seed consumer's update feed based on when a potential consumer views the update feed of the seed consumer. For example, an advertiser may present an advertisement related to the update feed of the seed consumer to a potential consumer who follows the seed consumer's updates soon after the potential consumer has seen the seed consumer's update. Accordingly, once a target list of potential consumers has been determined, the implementation of presenting advertisements may be contingent on when the potential consumer has viewed an item, such as an e-mail, an instant message, and/or update, etc. that references a subject of the advertisement. As such, embodiments of the present invention may generate a target list of potential consumers who may then be presented advertisements from a merchant. In alternative embodiments, a target list of potential consumers may be presented advertisements in response to receiving a request from a merchant to present advertisements to a target list of potential consumers.

Accordingly, in one embodiment, the present invention provides computer-storage media having computer-executable instructions embodied thereon that, when executed, perform a method of generating a target list of potential consumers based on networking site interactions of the potential consumers with consumers. The method includes receiving a set of consumers. Each consumer of the set of consumers may have a first characteristic. The method also includes determining a set of potential consumers based on the set of consumers. Each potential consumer of the set of potential consumers may be a networking site relation of at least one consumer of the set of consumers that is one degree of separation from the potential consumer. A subset of the set of potential consumers is then determined. Each potential consumer of the subset may have a second characteristic. A target list is then generated, where the target list comprises at least a portion of the subset of potential consumers.

In another embodiment, the present invention provides computer-storage media having computer-executable instructions embodied thereon that, when executed, perform a method of presenting advertisements to a target list of potential consumers generated from a set of seed consumers based on networking site interactions of the potential consumers with seed consumers of the set of seed consumers. The method includes receiving a target list request from an advertiser. The advertiser may comprise an advertising entity. Further, the target list may comprise a set of potential consumers to receive advertisements from the advertiser. A set of seed consumers is then received. The seed consumers may be associated with the advertiser. The method also includes determining a set of potential consumers based on the set of seed consumers. Each potential consumer of the set of potential consumers may be a networking site relation of at least one seed consumer that is one degree of separation from the potential consumer. Further, a subset of potential consumers is determined based on the set of potential consumers. Each potential consumer of the subset of potential consumers may share a second characteristic. A target list of potential consumers is then generated. The target list of potential consumers comprises at least a portion of the subset of potential consumers. The target list of potential consumers is then provided to the advertiser.

A third embodiment of the present invention provides computer-storage media having computer-executable instructions embodied thereon that, when executed, perform a method of presenting advertisements to a target list of a threshold number of potential consumers generated from a group of seed consumers based on networking site interactions of the potential consumers with seed consumers of the group of seed consumers. The method includes generating an advertisement to present to a target list of potential consumers. An advertiser target list request associated with the advertisement is then received. The requested target list comprises a threshold number of potential consumers to receive the advertisement. A set of seed consumers is then received. Each seed consumer has purchased at least one item from the advertiser within a threshold period of time. Further, each seed consumer subscribes to a networking site. Based on the set of seed consumers, a first set of potential consumers is determined. Each potential consumer of the first set of potential consumers subscribes to the networking site. Additionally, each potential consumer of the first set of potential consumers is one degree of separation from at least one seed consumer. A subset of potential consumers is then determined based on the first set of potential consumers. Each potential consumer of the subset of potential consumers shares a characteristic. A determination is then made as to whether the subset of potential consumers comprises the threshold number of potential consumers.

Upon determining the subset of potential consumers comprises the threshold number of potential consumers, a target list is generated. The target list comprises the subset of potential consumers. Alternatively, upon determining the subset of potential consumers comprises less than the threshold number of potential consumers, a second set of potential consumers is determined. The second set of potential consumers is based on the set of seed consumers, where each potential consumer of the second set of potential consumers is two degrees of separation from at least one seed consumer. Further, each potential consumer of the second set of potential consumers subscribes to the networking site. A determination is then made that the sum of the first set of potential consumers and the second set of potential consumers comprises the threshold number of potential consumers. A target list of potential consumers is then generated, the target list comprising at least a portion of the sum of the first set of potential consumers and the second set of potential consumers. Under either alternative method for generating a target list, the advertisement is then presented to the target list of potential consumers.

Having described an overview of embodiments of the present invention, an exemplary operating environment suitable for implementing embodiments hereof is described below.

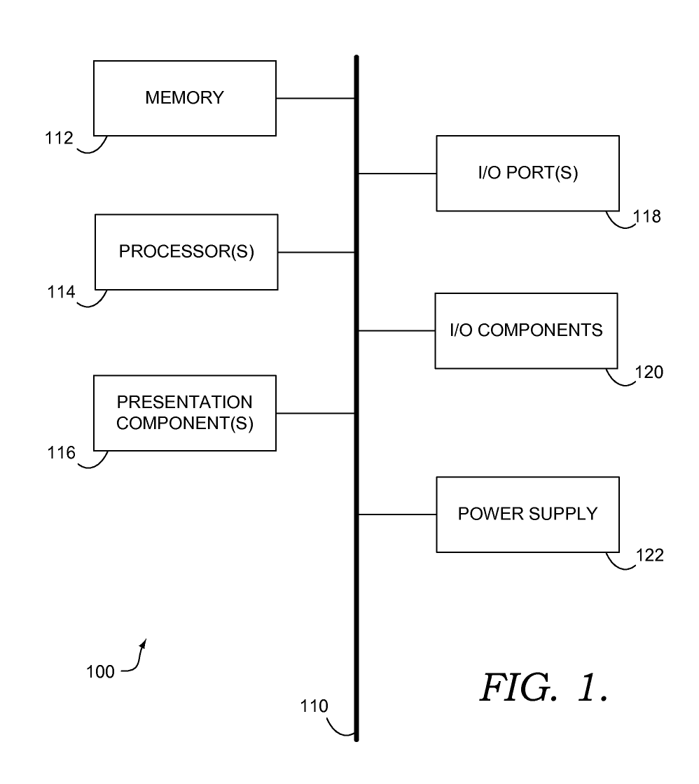

Referring to the drawings in general, and initially to FIG. 1 in particular, an exemplary computing device suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be practiced in a variety of system configurations, including handheld devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “handheld device,” etc., as all are contemplated within the scope of FIG. 1 and reference to “computer” or “computing device.”

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O modules 120. The presentation module(s) 116 present data indications to a potential consumer or other device. Exemplary presentation modules include a display device, speaker, printing module, vibrating module, and the like. The I/O ports 118 allow computing device 100 to be logically coupled to other devices including the I/O modules 120, some of which may be built in. Illustrative modules include a microphone, joystick, game pad, satellite dish, scanner, printer, wireless device, and the like.

Merchants are interested in presenting advertisements to potential consumers who are likely to act in response to the advertisements presented. For example, sellers of sporting goods may present commercials for sporting products during sporting events, such a televised football game. By spending resources on advertising groups that are likely to be more responsive than the average group of consumers, merchants gain efficiency in money spent on advertisements. Embodiments of the present invention provide methods for generating target groups based on a set(s) of seed consumers associated with an advertiser, such as a merchant. In particular, methods are provided for generating a targeted list of potential consumers and providing advertisements from the advertiser to the potential consumers on the target list generated.

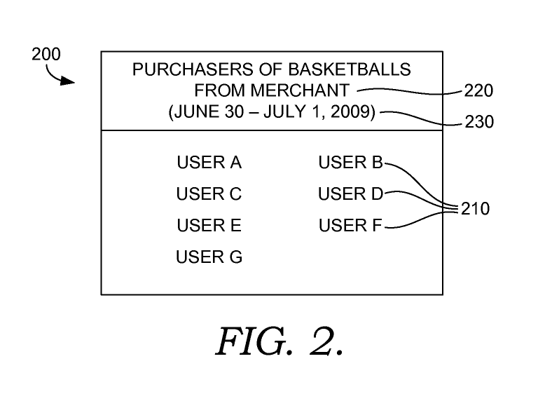

In embodiments, a request is received from an advertiser, such as a merchant, for a target list of potential consumers. In order to generate the target list of potential consumers, a list of seed consumers is generated. FIG. 2 illustrates an exemplary listing 200 of seed consumers 210 associated with a merchant 220, in accordance with an embodiment of the present invention. In particular, listing 200 comprises seed consumers 210 designated as users A-G. Users A-G are associated with merchant 220 because users A-G purchased a basketball from merchant 220 during time period 230. As such, seed consumers 210 comprise users A-G who share at least a first characteristic. In the example above, the shared characteristics of users A-G 210 were at least 1) they bought an item from the merchant; 2) they shopped within time period 230; and 3) they purchased a basketball.

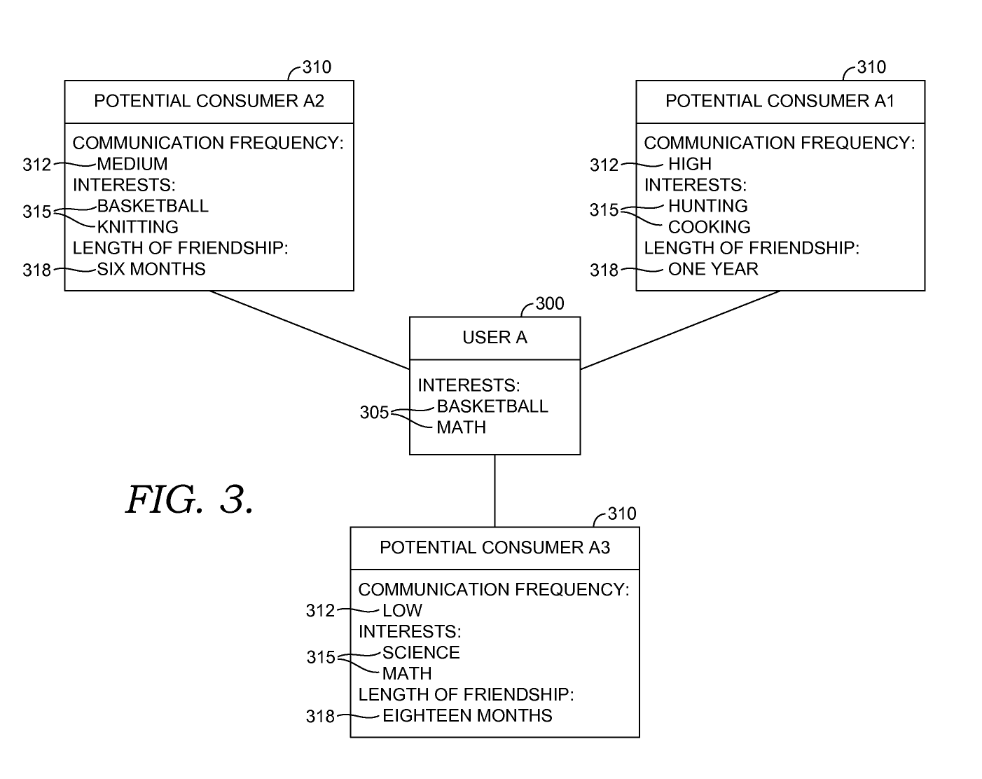

Once a listing 200 of seed consumers 210 has been generated, a first set of consumers may be generated based on the listing 200 of seed consumers 210. As an example, FIG. 3 illustrates exemplary first-degree friends 310 of one of the seed consumers of FIG. 2, in accordance with an embodiment of the present invention. The seed consumer 300 is designated as user A. Further, user A includes a set of interests 305. In particular, interests of user A comprise “basketball” and “math.” Further, first-degree friends 310 of user A are designated potential consumer A1, potential consumer A2, and potential consumer A3, respectively. Further, each of first-degree friends 310 includes profile information such as communication frequency 312, set of interests 315, and length of friendship 318.

In embodiments, communication frequency 312 represents how frequently each potential consumer of first-degree friends 310 communicates with user A. As seen in FIG. 3, potential consumer A1 has been in a high frequency of communication with user A; potential consumer A2 has been in medium frequency communication with user A; and potential consumer A3 has been in low frequency communication with user A. Further, each set of interests 315 represent the interests of each potential consumer A1, A2, and A3, respectively. In particular, interests of potential consumer A1 comprise “hunting” and “cooking;” interests of potential consumer A2 comprise “basketball” and “knitting;” and interests of potential consumer A3 comprise “science” and “math.”

Further, length of friendship 318 represents how long each potential consumer of first-degree friends 310 has been associated with user A. In particular, FIG. 3 illustrates how long potential consumers A1, A2, and A3 have been associated with user A on a social-networking site. As seen in FIG. 3, potential consumer A1 has been a friend of user A for one year; potential consumer A2 has been a friend of user A for six months; and potential consumer A3 has been a friend of user A for eighteen months. In embodiments, the relationships between user A and potential consumers A1-A3 may be used as filters for target lists of potential consumers.

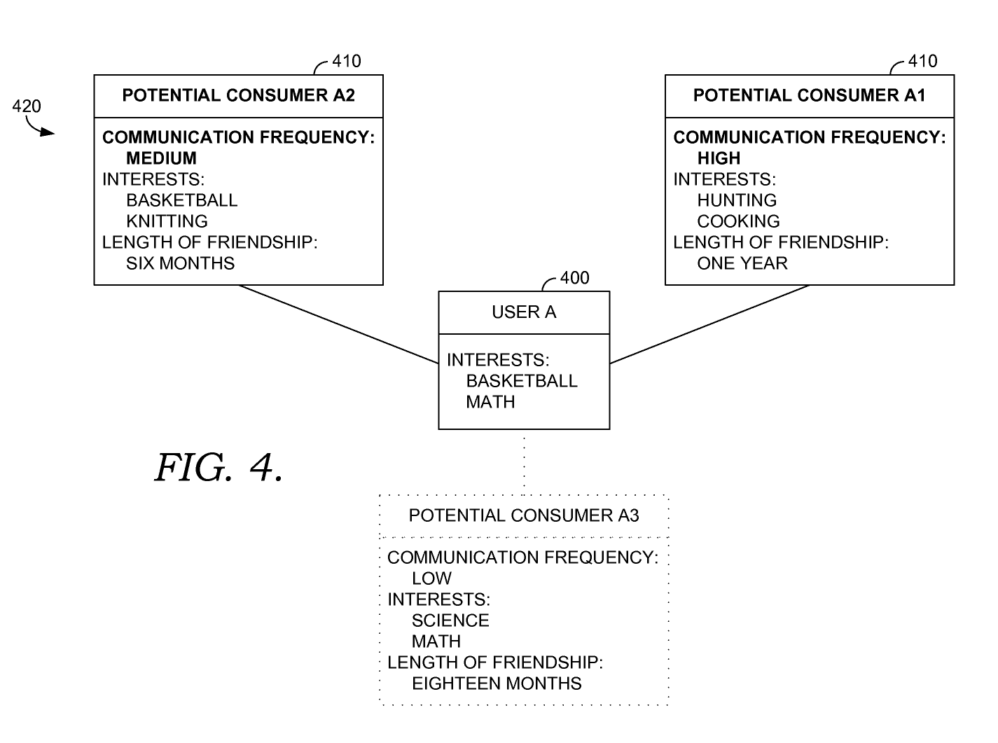

In order to increase the effectiveness of a target list of potential consumers, a set of potential consumers may be filtered to comprise a second set of potential consumers who share a second characteristic. FIG. 4 illustrates an exemplary filtered listing 420 of the first-degree friends shown in FIG. 3, in accordance with an embodiment of the present invention. In particular, filtered listing 420 has selected first-degree friends 410 of seed consumer 400, such as user A, who have at least medium frequency communication with user A. As such, filtered listing 420 comprises first-degree friends 410 designated as potential consumer A1 and potential consumer A2.

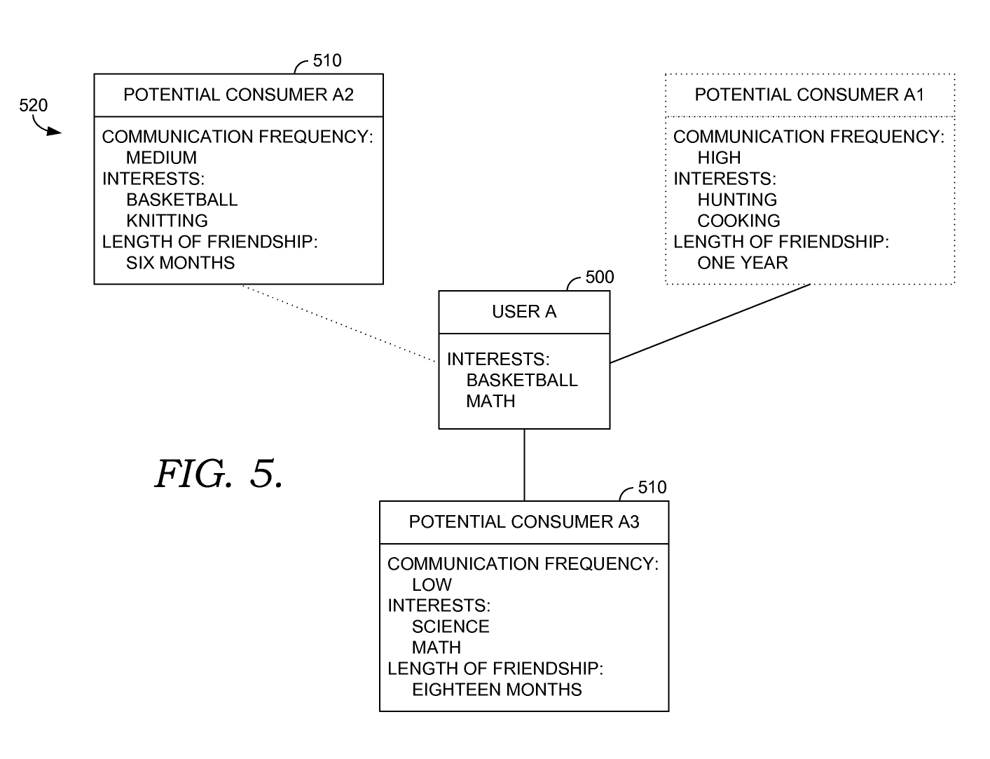

In accordance with embodiments of the present invention, first-degree friends of a seed consumer, such as user A, may also be filtered based on interests. FIG. 5 illustrates an alternative filtered listing 520 of first-degree friends shown in FIG. 3, in accordance with an embodiment of the present invention. In particular, filtered listing 520 comprises selected first-degree friends 510 who share at least one interest with seed consumer 500, such as user A. In FIG. 5, potential consumer A1 does not share any interests with user A; potential consumer A2 shares an interest of “basketball” with user A; and potential consumer A3 shares an interest of “math” with user A. Accordingly, filtered listing 520 comprises selected first-degree friends 510 designated as potential consumer A2 and potential consumer A3.

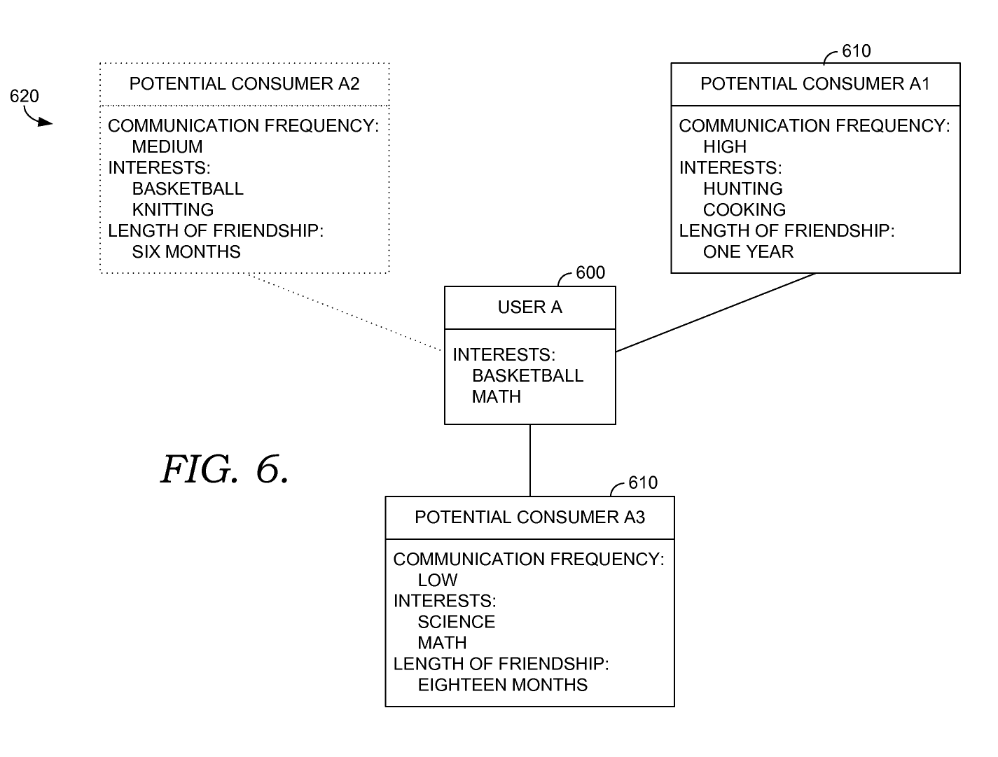

In further embodiments, first-degree friends of a seed consumer, such as user A, may be filtered based on length of friendship. Accordingly, FIG. 6 illustrates a further filtered listing 620 of first-degree friends shown in FIG. 3, in accordance with an embodiment of the present invention. In particular, filtered listing 620 comprises selected first-degree friends 610 who have been friends with seed consumer 600, such as user A, for at least a threshold amount of time. As seen in FIG. 6, filtered listing 620 comprises selected first-degree friends 610 who have been friends with user A for at least ten months. In FIG. 6, potential consumer A1 has been friends with user A for one year; potential consumer A2 has been friends with user A for six months; and potential consumer A3 has been friends with user A for eighteen months. Accordingly, filtered listing 620 comprises selected first-degree friends 610 designated as potential consumer A1 and potential consumer A3.

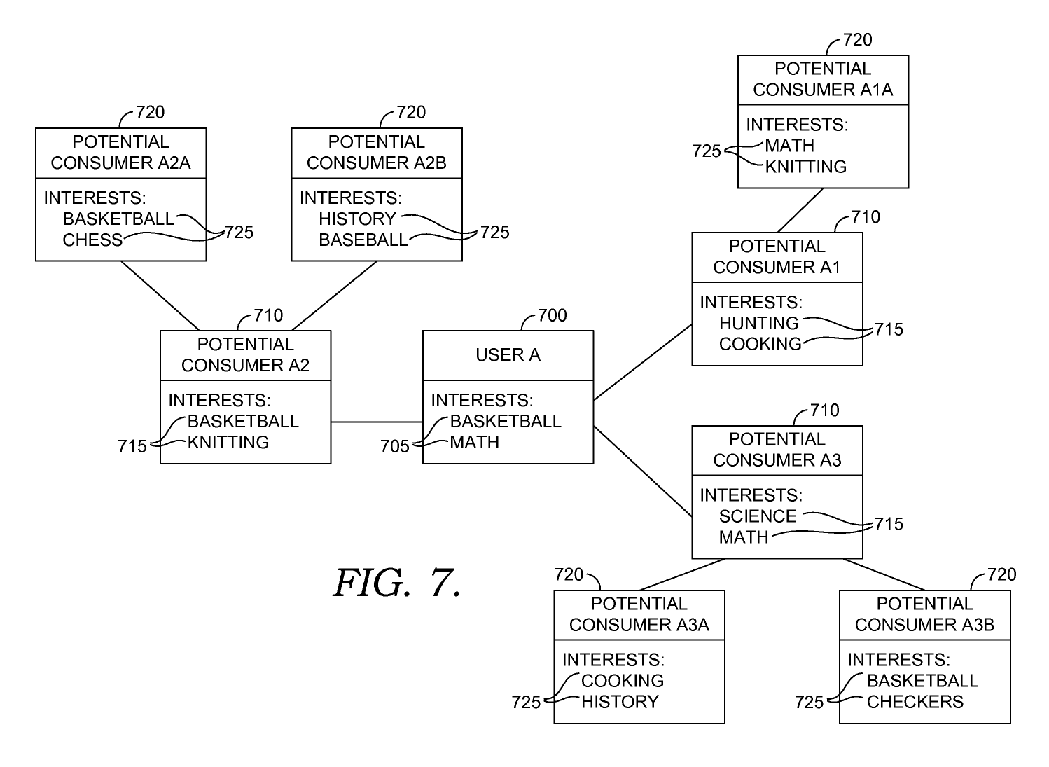

FIGS. 4-6 above illustrate methods of filtering first-degree friends of a seed consumer. In further embodiments, though, a listing of first-degree friends may not comprise a threshold number of potential consumers for a target list of potential consumers. In order to increase a number of potential consumers, a set of potential consumers may comprise not only first-degree friends of seed consumers, but may also comprise second-degree friends of seed consumers. Accordingly, FIG. 7 illustrates exemplary first-degree friends 710 and second-degree friends 720 of seed consumer 700, of one of the seed consumers of FIG. 2 (User A), in accordance with an embodiment of the present invention.

Similar to embodiments above, seed consumer 700 may be designated as user A. Further, user A includes a set of interests 705. In particular, interests of user A comprise “basketball” and “math.” Further, first-degree friends 710 of user A are designated potential consumer A1, potential consumer A2, and potential consumer A3, respectively. Further, each of first-degree friends 710 includes a set of interests 715. Additionally, second-degree friends 720 of user A are designated as potential consumer A1A, potential consumer A2A, potential consumers A2B, potential consumer A3A, and potential consumer A3B, respectively. Further, potential consumers A1A-A3A include a set of interests 725.

As described above, a group of potential consumers may be filtered to increase the effectiveness of a target list of potential consumers. When filtering a group of first-degree friends and second-degree friends of user A, embodiments are discussed where a filter may be performed on the combined group of first-degree friends and second-degree friends. Additionally, embodiments are discussed where a filter is placed on first-degree friends and, further, placed on second-degree friends associated with the resulting first-degree friends. In alternative embodiments, however, filters may be performed in a number of iterations; the embodiments described below are provided to clarify embodiments, and are not meant to limit the construction of potential embodiments that are covered by embodiments of the present invention.

Each set of interests 715 represent the interests of each potential consumer A1, A2, and A3, respectively. In particular, interests of potential consumer A1 comprise “hunting” and “cooking;” interests of potential consumer A2 comprise “basketball” and “knitting;” and interests of potential consumer A3 comprise “science” and “math.”Further, each set of interests 725 represent the interests of each potential consumer A1A, A2A, A2B, A3A, and A3B, respectively. In particular, interests of potential consumer A1A comprise “math” and “knitting;” interests of potential consumer A2A comprise “basketball” and “chess;” interests of potential consumer A2B comprise “history” and “baseball;” interests of potential consumer A3A comprise “cooking” and “history;” and interests of potential consumer A3B comprise “basketball” and “checkers.” In embodiments, the relationships between user A and potential consumers A1-A3 and/or the relationship between user A and potential consumers A1A-A3B may be used as filters for target lists of potential consumers.

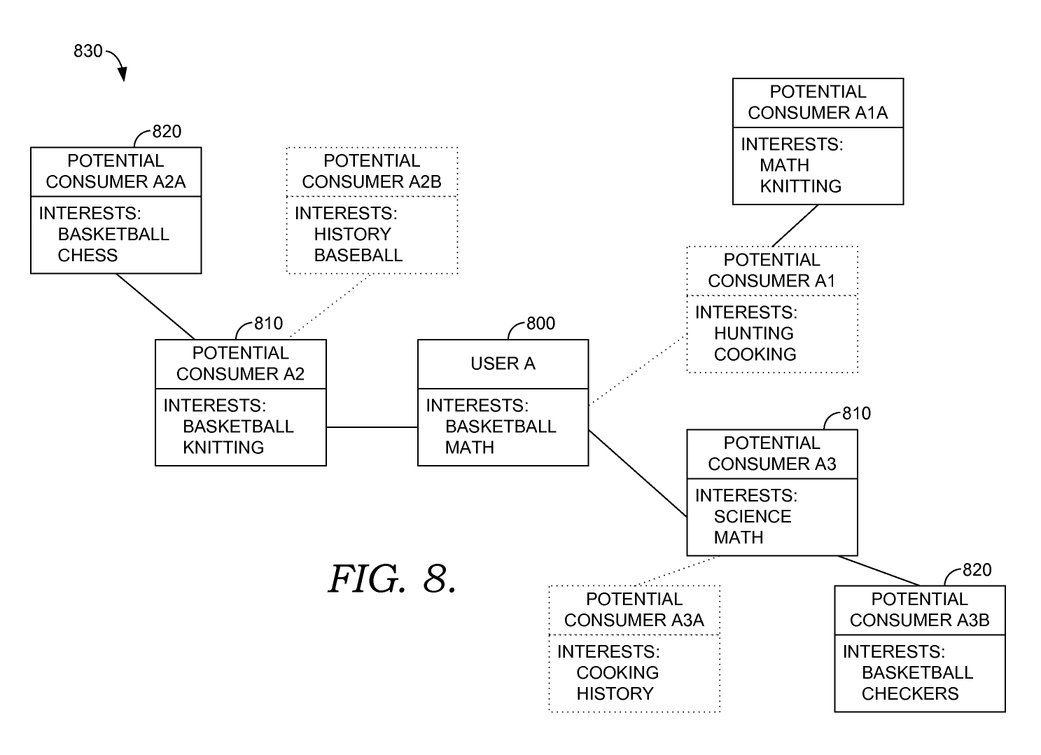

Accordingly, FIG. 8 illustrates an exemplary filtered listing 830 of first-degree friends and second-degree friends of FIG. 7, in accordance with an embodiment of the present invention. In particular, filtered listing 830 comprises filtered first-degree friends 810 and filtered second-degree friends 820 who share at least one interest with seed consumer 800, referred to as user A. In FIG. 8, potential consumer A1 does not share any interests with user A; potential consumer A2 shares an interest of “basketball” with user A; potential consumer A3 shares an interest of “math” with user A; potential consumer A1A shares an interest of “math” with user A; potential consumer A2A shares an interest of “basketball” with user A; potential consumer A2B does not share any interests with user A; potential consumer A3A does not share any interests with user A; and potential consumer A3B shares an interest of “basketball” with user A. Accordingly, filtered listing 800 comprises potential consumers A1A, A2, A2A, A3, and A3B of first-degree friends 810 and second-degree friends 820, respectively.

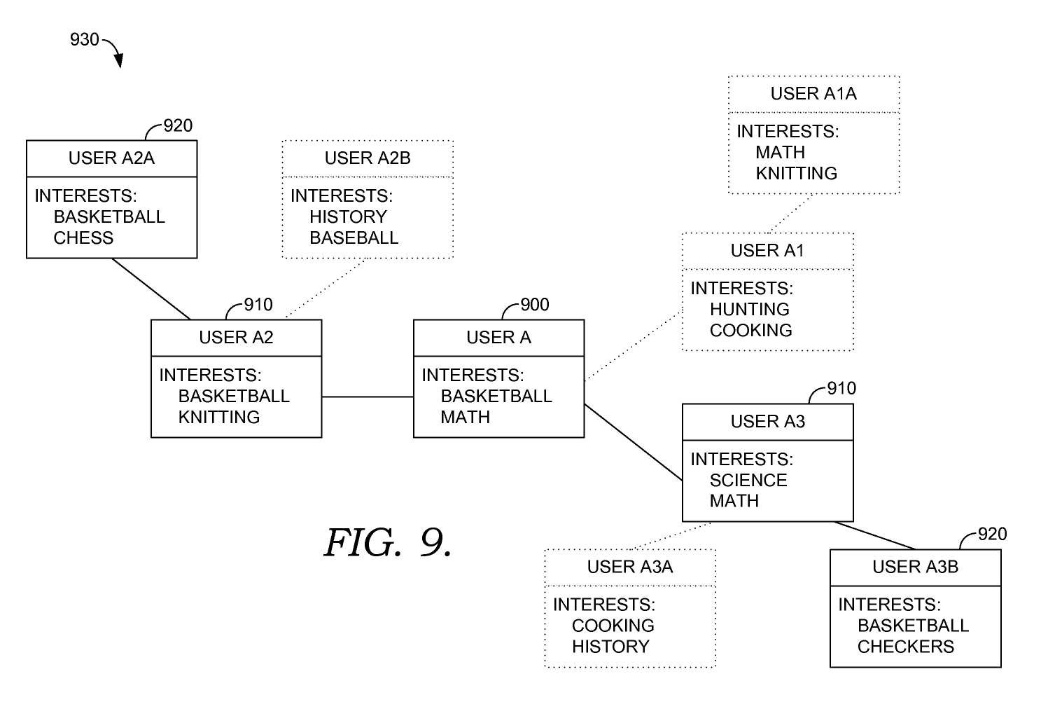

In further embodiments, FIG. 9 illustrates a filter 930. In particular, FIG. 9 illustrates second-degree friends 920 of filtered first-degree friends 910 of a seed consumer 900 associated with a merchant in accordance with an embodiment of the present invention. In particular, filtered listing 930 comprises filtered first-degree friends 910. Further, filtered listing 930 further comprises selected second-degree friends 920 who are associated with filtered first-degree friends 910, where each of selected second-degree friends 920 shares at least one interest with user A. In FIG. 9, potential consumer A1 does not share any interests with user A; potential consumer A2 shares an interest of “basketball” with user A; potential consumer A3 shares an interest of “math” with user A. Accordingly, filtered listing 930 comprises potential consumers A2 and A3 of first-degree friends 910. Further, based on selected first-degree friends 910, potential consumer A1A shares an interest of “math” with user A; potential consumer A2A shares an interest of “basketball” with user A; potential consumer A2B does not share any interests with user A; potential consumer A3A does not share any interests with user A; and potential consumer. A3B shares an interest of “basketball” with user A. Accordingly, filtered listing 930 comprises potential consumers A2A and A3B of second-degree friends 920, respectively.

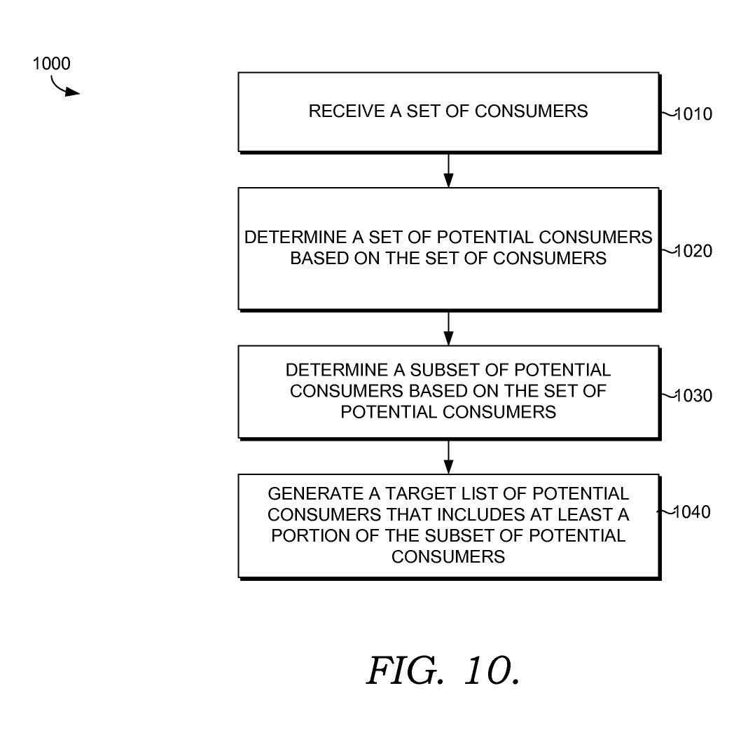

FIG. 10 is a flow diagram 1000 illustrating a method of generating a target list of potential consumers based on networking site interactions of the potential consumers with consumers, in accordance with an embodiment of the present invention. Initially, as indicated at block 1010, a set of consumers is received. In embodiments, each consumer of the set of consumers has a first characteristic. At block 1020, a set of potential consumers is determined based on the set of consumers. In embodiments, each potential consumer of the set of potential consumers is one degree of separation from at least one consumer of the set of consumers. In further embodiments, each potential consumer of the set of potential consumers is distinct from the consumers of the set of consumers. At block 1030, a subset of the set of potential consumers is determined. Each potential consumer of the subset of potential consumers may share a second characteristic. At block 1040, a target list of potential consumers is generated. In embodiments, the target list of potential consumers includes at least a portion of the subset of potential consumers.

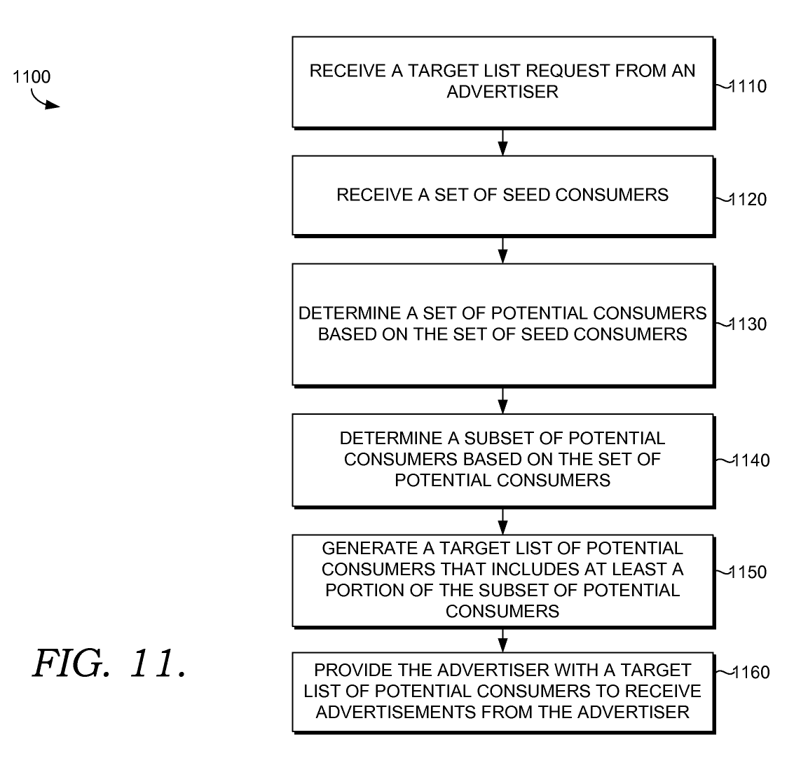

FIG. 11 is a flow diagram illustrating a method 1100 of presenting advertisements to a target list of potential consumers generated from a set of seed consumers based on networking site interactions of the potential consumers with seed consumers of the set of seed consumers, in accordance with an embodiment of the present invention. As indicated at block 1110, a target list request is received from an advertiser. The target list request may comprise a set of potential consumers to receive advertisements from the advertiser. In embodiments, an advertiser may comprise a merchant. In further embodiments, an advertiser may comprise a person, group of people, and/or an organization wishing to disseminate information to a target list of potential consumers. Accordingly, an advertiser may use a target list to inform potential consumers of sales, events, requests for membership, requests for information, and/or other promotional messages.

At block 1120, a set of seed consumers is received. Each seed consumer may be associated with the advertiser. At block 1130, a set of potential consumers is determined based on the set of seed consumers. Each potential consumer of the set of potential consumers may be one degree of separation from at least one seed consumer. At block 1140, a subset of the set of potential consumers may be determined. Each potential consumer of the subset of potential consumers may share a second characteristic. At block 1150, a target list of potential consumers is generated. The target list of potential consumers may include at least a portion of the subset of potential consumers. At block 1160, a target list is provided to the advertiser. Further, the potential consumers of the target list may receive advertisements from the advertiser.

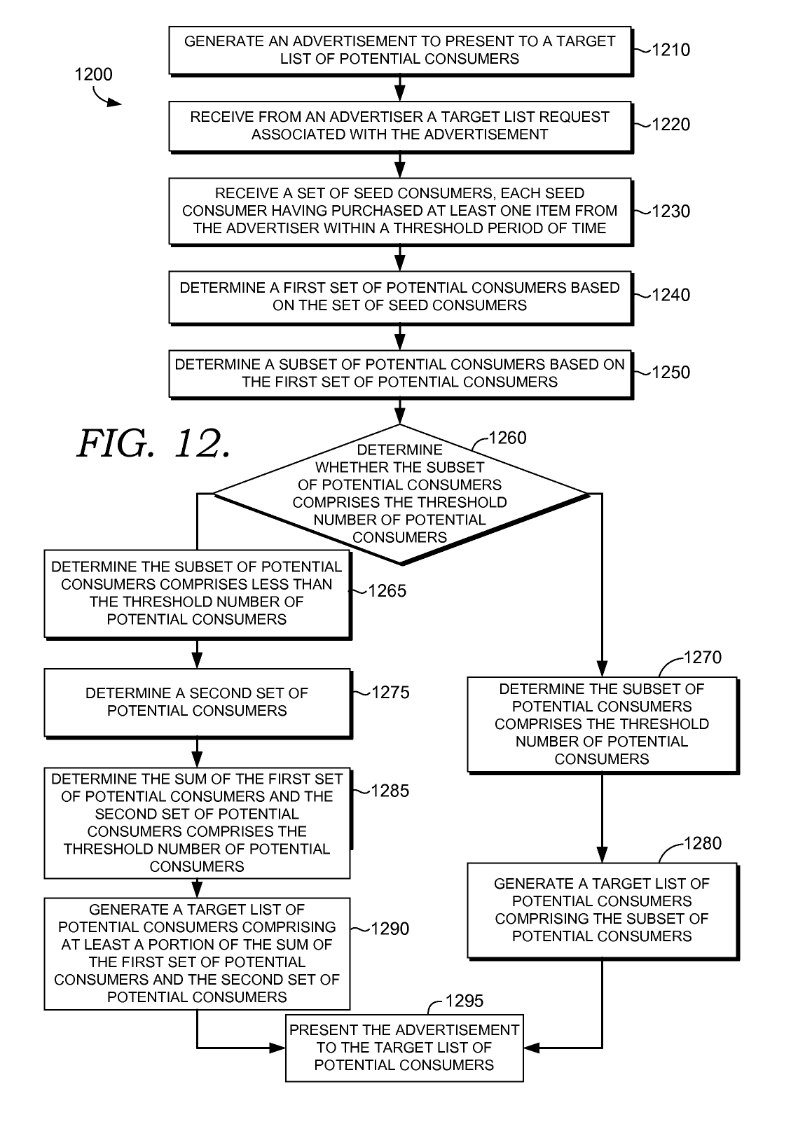

FIG. 12 is a flow diagram 1200 illustrating a method of presenting advertisements to a target list of a threshold number of potential consumers generated from a group of seed consumers based on networking site interactions of the potential consumers with seed consumers of the group of seed consumers, in accordance with an embodiment of the present invention. As indicated at block 1210, an advertisement is generated. In embodiments, the advertisement is generated to be presented to a target list of potential consumers. At block 1220, a target list request is received from an advertiser. The target list request may be associated with the advertisement. Further, the target list may comprise a threshold number of potential consumers to receive the advertisement. At block 1230, a set of seed consumers is received. In embodiments, each seed consumer has purchased at least one item from the advertiser within a threshold period of time. Further, each seed consumer may subscribe to a networking site.

At block 1240, a first set of potential consumers is determined based on the set of seed consumers. Further, each potential consumer of the first set of potential consumers may subscribe to the networking site. Additionally, each potential consumer of the first set of potential consumers may be one degree of separation from at least one seed consumer. At step 1250, a subset of the first set of potential consumers is determined. Each potential consumer of the subset of potential consumers may share a characteristic. At block 1260, a determination is made whether the second set of potential consumers comprises the threshold number of potential consumers.

Upon determining the subset of potential consumers comprises the threshold number of potential consumers at 1270, a target list of potential consumers is generated at block 1280. The target list of potential consumers may comprise the subset of potential consumers. Upon determining the subset of potential consumers comprises less than a threshold number of potential consumers at block 1265, a second set of potential consumers is determined at block 1275. The third set of potential consumers may be based on the set of seed consumers. Further, each potential consumer of the third set of potential consumers may subscribe to the networking site. Additionally, each potential consumer of the second set of potential consumers is two degrees of separations from at least one seed consumer. The sum of the first set of potential consumers and the second set of potential consumers is then determined at block 1285 to comprise at least a threshold number of potential consumers. At block 1290, a target list of potential consumers is then generated. The target list of potential consumers may comprise at least a portion of the sum of the first set of potential consumers and the second set of potential consumers. Then, at block 1295, the advertisement is presented to the target list of potential consumers. The presentation of the advertisement is independent of the method used to generate the target list of potential consumers.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. Computer-storage media having computer-executable instructions embodied thereon that, when executed, perform a method of generating a target list of potential consumers based on networking site interactions of the potential consumers with consumers, the method comprising:
receiving a set of consumers, each consumer of the set of consumers having a first characteristic;
determining a set of potential consumers based on the set of consumers, each potential consumer being a networking site relation of at least one consumer that is one degree of separation from the potential consumer;
determining a subset of the set of potential consumers, each potential consumer of the subset having a second characteristic; and
generating a target list of potential consumers that includes at least a portion of the subset of potential consumers.

2. The computer-storage media of claim 1, wherein each consumer of the set of consumers is a seed consumer.

3. The computer-storage media of claim 2, wherein receiving the set of consumers comprises identifying the set of consumers.

4. The computer-storage media of claim 1, wherein each potential consumer of the set of potential consumers is not a consumer of the set of consumers.

5. The computer-storage media of claim 1, wherein each potential consumer of the set of potential consumers is a networking site relation of at least one consumer that is more than one degree of separation from the potential consumer.

6. The computer-storage media of claim 1, wherein the method further comprises:
receiving a request for the target list of potential consumers from an advertising entity.

7. The computer-storage media of claim 6, wherein each consumer of the set of consumers is associated with the advertising entity.

8. The computer-storage media of claim 7, wherein the method further comprises:
presenting an advertisement related to the advertising entity on a computing device associated with a potential consumer of the target list of potential consumers.

9. The computer-storage media of claim 1, wherein each of the first and second characteristics comprises one of visiting a website of an advertiser, making a purchase from the advertiser, subscribing to a blog of the advertiser, initiating a search query, where the search query matches a keyword from the advertiser, and having an interest on the profile of the potential consumer that matches a keyword from the advertiser.

10. The computer-storage media of claim 1, wherein each consumer of the set of consumers subscribes to a common network messaging service.

11. The computer-storage media of claim 10, wherein at least one potential consumer of the first set of consumers has a profile associated with the common messaging service.

12. Computer-storage media having computer-executable instructions embodied thereon that, when executed, perform a method of presenting advertisements to a target list of potential consumers generated from a set of seed consumers based on networking site interactions of the potential consumers with seed consumers of the set of seed consumers, the method comprising:
receiving a target list request from an advertiser, where a target list comprises a set of potential consumers to receive advertisements from the advertiser;
receiving the set of seed consumers, each seed consumer being associated with the advertiser;
determining a set of potential consumers based on the set of seed consumers, each potential consumer of the set of potential consumers being a networking site relation of at least one seed consumer that is one degree of separation from the potential consumer;
determining a subset of potential consumers based on the set of potential consumers, each potential consumer of the subset of potential consumers having a second characteristic;
generating a target list of potential consumers comprising at least a portion of the subset of potential consumers; and
providing the advertiser with a target list of potential consumers to receive advertisements from the advertiser.

13. The computer-storage media of claim 12, wherein each potential consumer of the set of potential consumers is not a consumer of the set of consumers.

14. The computer-storage media of claim 12, wherein each potential consumer of the subset of potential consumers is not a consumer of the set of consumers.

15. The computer-storage media of claim 12, wherein a characteristic comprises at least one of visiting a website of the advertiser, making a purchase from the advertiser, subscribing to a blog of the advertiser, initiating a search query, where the search query matches a keyword from the advertiser, and having an interest on the profile of the potential consumer that matches a keyword from the advertiser.

16. The media of claim 12, wherein each potential consumer of the set of potential consumers subscribes to a messaging service.

17. The media of claim 16, wherein at least one potential consumer of the set of potential consumers has a profile on the messaging service.

18. Computer-storage media having computer-executable instructions embodied thereon that, when executed, perform a method of presenting advertisements to a target list of a threshold number of potential consumers generated from a group of seed consumers based on networking site interactions of the potential consumers with seed consumers of the group of seed consumers, the method comprising:
generating an advertisement to present to a target list of potential consumers;
receiving from an advertiser a target list request associated with the advertisement, the target list comprising a threshold number of potential consumers to receive the advertisement;
receiving a set of seed consumers, each seed consumer having purchased at least one item from the advertiser within a threshold period of time and each seed consumer having subscribed to a networking site;
determining a first set of potential consumers based on the set of seed consumers, each potential consumer having subscribed to the networking site, and each potential consumer being one degree of separation from at least one seed consumer;
determining a subset of the first set of potential consumers, each potential consumer of the subset of potential consumers having a characteristic;
determining whether the subset of potential consumers comprises the threshold number of potential consumers;
upon determining the subset of potential consumers comprises the threshold number of potential consumers,
generating a target list of potential consumers comprising the subset of potential consumers;
upon determining the subset of potential consumers comprises less than the threshold number of potential consumers,
determining a second set of potential consumers based on the set of seed consumers, each potential consumer of the second set of potential consumers having subscribed to the messenger service and each potential consumer of the second set of potential consumers being two degrees of separation from at least one seed consumer;
determining the sum of the first set of potential consumers and the second set of potential consumers comprises the threshold number of potential consumers;
generating a target list of potential consumers comprising at least a portion of the sum of the first set of potential consumers and the second set of potential consumers; and
presenting the advertisement to the target list of potential consumers.

19. The computer-storage media of claim 18, wherein a characteristic comprises at least one of visiting a website of the advertiser, making a purchase from the advertiser, subscribing to a blog of the advertiser, initiating a search query, where the search query matches a keyword from the advertiser, and having an interest on the profile of the potential consumer that matches a keyword from the advertiser.

20. The computer-storage media of claim 18, wherein the portion of the sum of the first set of potential consumers and the second set of potential consumers comprises the threshold number of potential consumers.
